(19) United States
(12) Patent Application Publication
(10) Pub. No.: US 2020/0327874 A1
(43) Pub. Date: Oct. 15, 2020

(54) BELL

(71) Applicant: Slone Studio Inc., Sausalito, CA (US)

(72) Inventors: Clinton N. SLONE, San Francisco, CA (US); Nicholaus M. SLONE, Bend, OR (US); Adam R.L. REINECK, Mill Valley, CA (US)

(21) Appl. No.: 16/822,503

(22) Filed: Mar. 18, 2020

Related U.S. Application Data
(60) Provisional application No. 62/831,295, filed on Apr. 9, 2019.

(51) Int. Cl. G10K 1/072; B62J 3/04

(52) U.S. Cl. CPC G10K 1/072; B62J 3/04

(57) ABSTRACT

A variety of bells are described. In one aspect, a support carries a bell body. A first portion of the support is positioned within the bell cavity and a second portion extends outside the bell cavity through the bell's mouth. A strike lever is coupled to the support at a location within the bell cavity. The strike lever is resiliently biased towards a neutral position that is spaced apart from the bell body. To ring the bell, a user presses the strike lever thereby spring loading the lever as the lever moves away from the bell strike surface. When the strike lever is released, the spring loading causes the strike lever to swing to strike the bell body to ring the bell. The strike lever is configured to strike the bell body while traveling in a direction having a radially outward vector component.

### CROSS-REFERENCE TO RELATED APPLICATIONS

This application claims priority of U.S. Provisional Application No. 62/831,295, filed on Apr. 9, 2019, which is incorporated herein by reference in its entirety.

### BACKGROUND

The present invention relates generally to bells, as for example small bells suitable for use on bicycles and in other settings.

Bells have been around for many years. For some bells, such as warning bells used on bicycles, it is desirable for the bell to be small, compact and lightweight, but still generate a loud and pleasant tone. The applicant has developed a compact bell design known as the Spurcycle Bell that has a dome shaped bell body formed from nickel brass that is carried by a support. The bell is rung by a hammer carried by a wire frame lever. The wire frame lever is pivotally coupled to the support at a location below the bell body and is configured so that the hammer strikes an external surface of the dome. A strap is provided to facilitate coupling the bell to structures such as bicycle handlebars.

Although the Spurcycle Bell and a variety of other existing bells work well, there are continuing efforts to develop alternative bell designs that are rugged, cost effective and generate desirable bell tones.

### SUMMARY

To achieve the foregoing and other objectives, a variety of new bell structures are described. In one aspect, a support carries a bell body. The bell body may include a bell cavity, a mouth, a lip, a head portion, a central axis, and a bell strike surface on an inner surface of the bell body. The head portion may include a central opening. A first portion of the support is positioned within the bell cavity and a second portion of the support extends outside the bell cavity through the bell body mouth. A strike lever is coupled to the support at a location within the bell cavity. The strike lever is configured to strike the bell strike surface to ring the bell. The strike lever is resiliently biased towards a neutral or nominal position at which the strike lever is spaced apart from the bell body. To ring the bell, a user presses the strike lever to deflect the strike lever from the neutral position thereby spring loading the strike lever and moving the strike lever away from the bell strike surface. When the strike lever is released with the strike lever moved away from the bell strike surface, the spring loading of the strike lever causes the strike lever to swing to strike the bell body to ring the bell. The strike lever is configured to strike the bell body to ring the bell while traveling in a direction having a vector component that is radially outward relative to the bell's central axis.

In some embodiments, the bell strike surface is on a fillet or chamfered surface on the inner surface of the bell body adjacent the lip. With this arrangement, the strike lever may be configured to strike the inner surface of the bell body on the filleted surface. In other embodiments, the strike lever is configured to strike the inner surface of the bell at an inner edge of the lip. In still other embodiments, the strike lever may strike the inner surface of the bell body at a location away from the lip.

In some embodiments, both the support and the strike lever are formed from plastic material. In some embodiments, the strike lever includes a strike surface that is configured to strike the bell strike surface to ring the bell. In others, the strike lever may include a hammer element that is configured to strike the bell strike surface to ring the bell.

In some embodiments, the strike lever is pivotally coupled to the support at the location within the bell cavity and the deflection caused by the user pressing the strike lever is pivotal rotation of the strike lever relative to the support. A variety of different pivoting structures may be used including hinges, joints, virtual pivots created by flexures or other bending elements, etc. In some embodiments a hinge is used that includes knuckles integrally formed on the support and spring lever respectively. In some embodiments, a torsion spring is provided to spring load the strike lever when the strike lever is deflected from the neutral position. In some embodiments, the strike lever includes one or more cams with each cam being engaged by a spring arm of the torsion spring. The cams may include a flat segment that defines the strike lever's nominal or neutral position.

In other embodiments, the strike lever body and the support body are integrally formed as a single plastic piece. In this arrangement the strike lever serves as a flexure that is resiliently biased towards the neutral position.

In other embodiments a helical coil spring or similar structure may be used to couple the strike lever to the support. With this arrangement, the coil spring resiliently biases the strike lever towards the neutral position.

In some embodiments, the support includes a strap that serves as a loop mount suitable for mounting the bell to a bicycle handlebar and other similarly dimensioned structures.

In some embodiments a cap is used to couple the bell body to the support. The cap may include a head portion and a shaft with the shaft being configured to pass through the central opening in the head portion of the bell body. The shaft engages the support to help hold the dome in place. In some embodiments, the dome includes an inwardly beveled section around the central opening and a flange that extends downward from the bevel. In some embodiments a rubber bushing positioned in a recess in the support receives the flange and serves to vibrationally isolate the bell body from the support.

### BRIEF DESCRIPTION OF THE DRAWINGS

The invention and the advantages thereof, may best be understood by reference to the following description taken in conjunction with the accompanying drawings in which:

FIGS. 1A and 1B are perspective views of a bell in accordance with one embodiment.

FIGS. 2A and 2B are a perspectives view of components of the bell of FIG. 1A with the dome hidden.

FIG. 3A is a perspective view of the bell dome utilized in the embodiment of FIG. 1A.

FIG. 3B is a cross-sectional view of the bell dome of FIG. 3A.

FIG. 4 is a perspective view of the strike lever of the embodiment of FIG. 1A.

FIG. 5 is a perspective view of the cap utilized in the embodiment of FIG. 1A.

FIGS. 6A and 6B are diagrammatic cross-sectional views illustrating selected bell body lip region geometries.

FIG. 7 is a perspective view of an alternative bell support structure.

FIG. 8 is a perspective view of a bell in accordance with a third embodiment.

FIG. 9 is a perspective view of the support and strike lever structure utilized in the embodiment of FIG. 8.

FIG. 10 is a perspective view of a bell in accordance with a fourth embodiment.

FIG. 11 is a perspective view of the support and strike lever structure utilized in the embodiment of FIG. 10.

FIG. 12 is a perspective view of a support and two part strike lever structure in accordance with a fifth embodiment.

FIG. 13 is a back perspective view of the two part strike lever structure utilized in the embodiment of FIG. 12.

FIG. 14A front perspective view of the lever arm portion of the two part strike lever of FIG. 13.

FIB. 14B is a front side view of the striker portion of the two part strike lever of FIG. 13.

FIG. 15 is a front perspective view of a strike lever structure in accordance with a sixth embodiment.

FIG. 16 is a back perspective view of the strike lever structure of FIG. 15.

In the drawings, like reference numerals are sometimes used to designate like structural elements. It should also be appreciated that the depictions in the figures are diagrammatic and not to scale.

### DETAILED DESCRIPTION

The present invention relates generally to bells and is particularly applicable to small bells such as bicycle bells that can be actuated by a user's finger action.

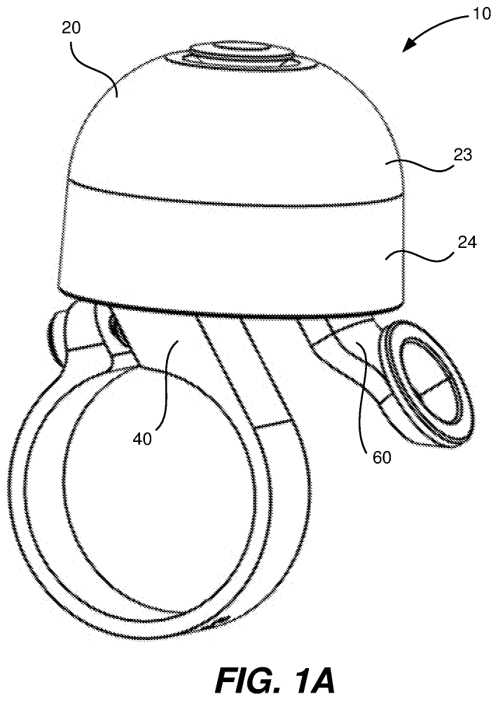

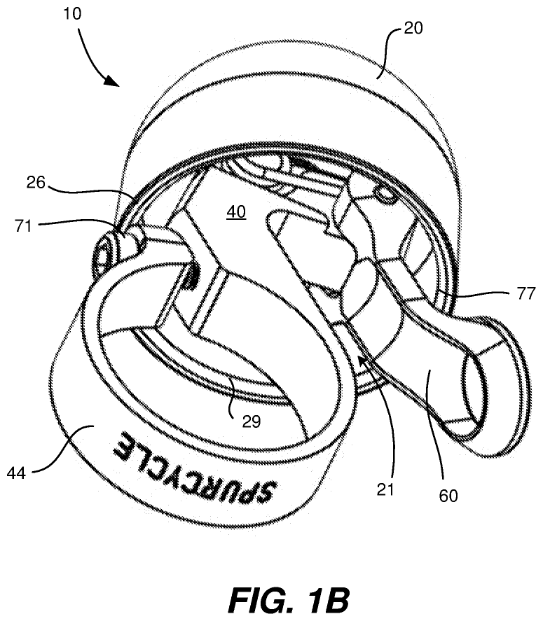

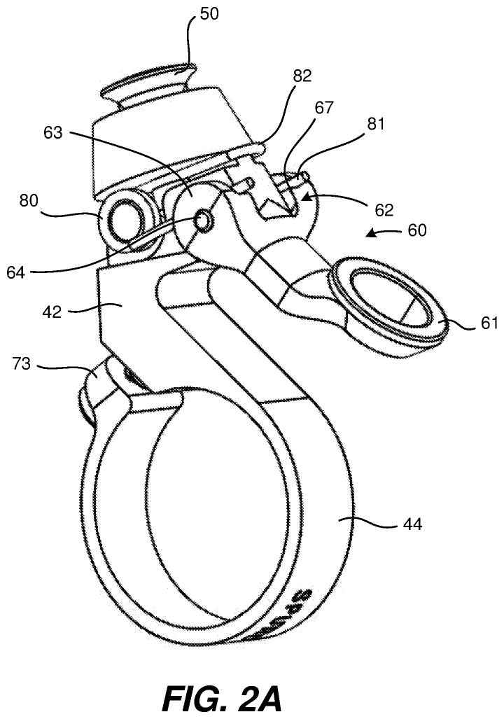

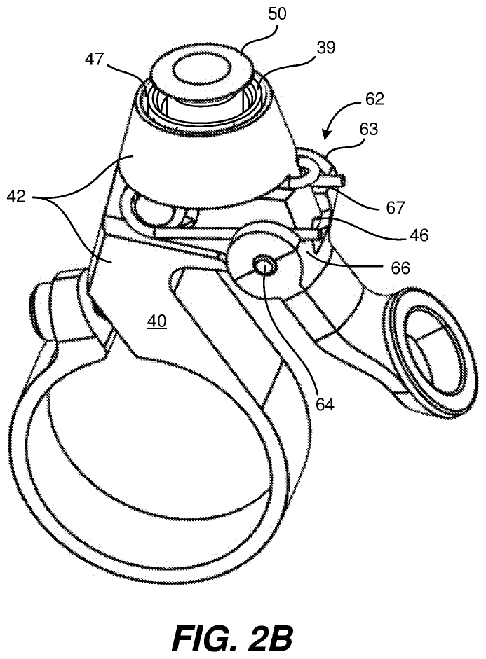

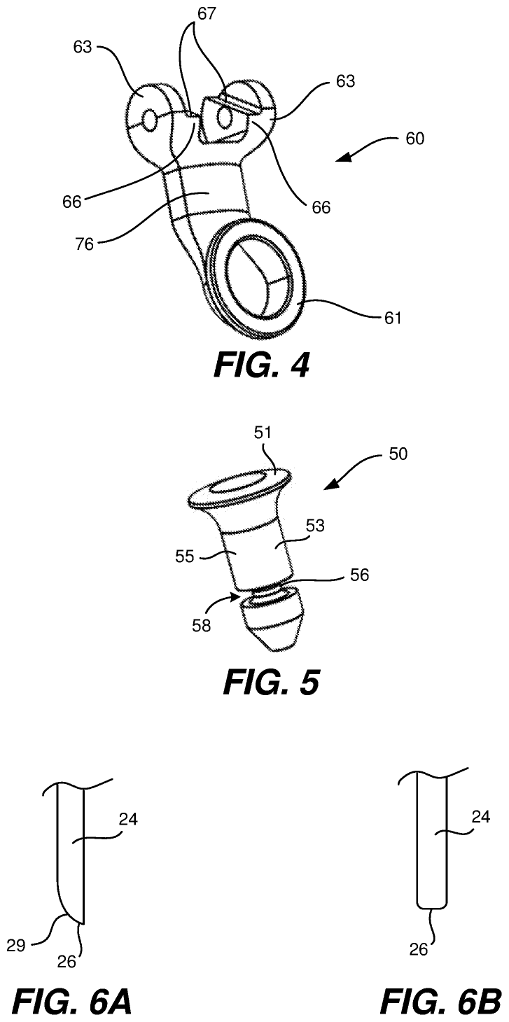

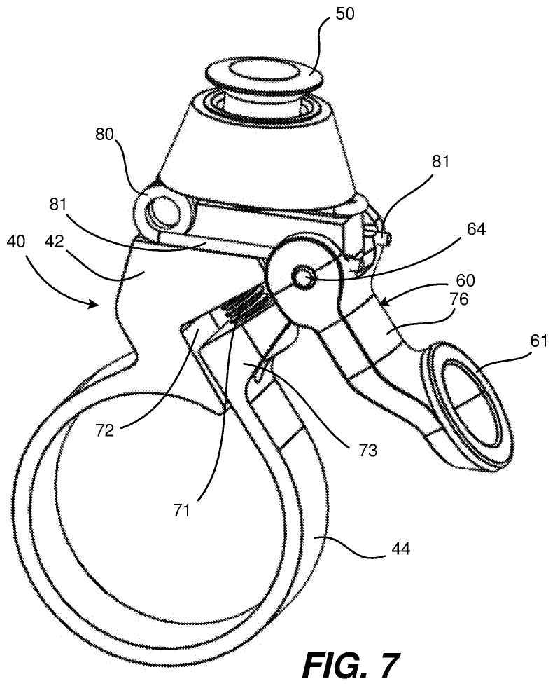

FIGS. 1-5 illustrate a bell 10 in accordance with one embodiment. The illustrated bell 10 includes a dome shaped bell body 20 having an internal bell cavity (dome cavity) 21, a support 40 and a strike lever 60 that is pivotally coupled to the support 40 at a location within the bell cavity. The support and strike levers are best seen in FIGS. 2, 4 and 7. FIGS. 2A and 2B are perspective views of components of the bell of FIG. 1A with the dome hidden. FIG. 4 is a perspective view of the strike lever of the embodiment of FIG. 1A. FIG. 7 is a perspective view of an alternative bell support structure that has many of the same components as the embodiment of FIG. 2A.

The bell body (dome) 20 includes a substantially hemispherical upper portion 23 and a substantial cylindrical skirt 24. The upper portion 23 is sometime referred to as the head and shoulder portions of the bell. The bottom of the bell body (i.e., the bottom of the skirt 24 in the illustrated embodiment) is sometimes referred to as a lip 26 and the large opening at the bottom of the bell is sometimes referred to as the mouth. As will be described in more detail below with reference to FIGS. 6A and 6B, in some embodiments, the inner surface 28 of the bell body skirt is filleted or rounded adjacent the lip thereby defining a fillet 29 on the inner surface adjacent the lip 26 (see, e.g., FIG. 6A). In other embodiments, there may be a sharper junction at the inner surface/lip junction (see, e.g., FIG. 6B). The head portion may also include a central opening 31 where the crown of the bell would be. The central opening may serve as the attachment point for attaching the bell body 20 to the support 40. The bell body may be formed from a variety of materials that produce good sound. For example, metallic materials such as nickel brass or brass work well.

The support 40 includes a base 42 and a strap 44. A cap 50 (or in other embodiments a fastener) may be used to secure the bell body 20 to the base portion of 42 of support 40. In some embodiments, the support 40 is formed as a single piece, molded plastic part. In other embodiments, the support 40 may be formed from multiple components, with the strap 44 and potentially other components being formed as independent parts. As best seen if FIG. 5, the cap 50 may include a head portion 51 and a shaft portion 53.

The strike lever 60 includes a finger pad 61 and is pivotally coupled to the support base 42 by a hinge 62. The hinge 62 includes a pair of spaced apart knuckles 63 that are integrally formed as part of the strike lever and an opposing knuckle 46 that is integrally formed as part of the support base 42. The knuckles 63, 46 receive pivot pin 64.

In the illustrated embodiments, the hinge 62 also includes a pair of cams 66 each having a face with a flat segment 67 thereon. The cams 66 cooperate with a spring 80 to heavily bias the strike lever 60 to a neutral position at which the strike lever 60 is spaced apart from bell body 20. In the embodiments illustrated in FIGS. 1-5, the spring 80 is a torsion spring having a pair of spring arms 81. The spring 80 is mounted on the support base 42 and the spring arms 81 are each arranged to engage the face of an associated cam as best seen in the embodiment of FIG. 7. In the neutral position, the spring arms press against the flat segments of the cams to help maintain the strike lever in the neutral position. Deflecting the strike lever 60 in either direction from its neutral position against the biasing force of the spring 80 will spring load the strike lever. Thus, when the strike lever is deflected from the neutral position against the force of the spring 80, the spring is loaded and will try to pull the strike lever 60 back towards the neutral position.

To ring the bell, a user presses the finger pad 61 to pivot the strike lever 60 relative to the support 40 thereby spring loading the strike lever and moving the lever away from the bell body. When the user releases the strike lever with the lever displaced sufficiently from the bell body, the spring loading of the strike lever causes the strike lever to swing to strike the bell body to thereby ring the bell. After striking the bell, the strike lever quickly recoils back towards the neutral position. The interactions between the cams 66 and spring 80 help quickly dampen oscillation of the strike lever. Preferably the size, weight and relative positioning of the components are such that the strike bar will only strike the bell once when it is released after being deflected sufficiently.

The bell 10 is preferably configured such that the majority of the support base 42, including the hinge 62 is received within the bell (dome) cavity 21. Therefore, the strike lever 60 is pivotally coupled to the support 40 at a location well within the bell cavity 21. Pressing on the finger pad 61 in the direction towards the central axis of the dome 20 causes the strike lever 60 to move further away from the dome. The travel of the strike lever is limited by the support. In the illustrated embodiment, the strike lever's inward range of travel is stopped when the back side of the lever 60 comes into contact with the strap 44. When the strike lever 60 is released from such a position, the lever recoils past the neutral position and a portion of the lever itself will strike the inner surface of the bell to thereby ring the bell. The region of the strike lever that impacts the bell is sometimes referred to as the lever's strike surface 76. The region of the bell body that is impacted by the strike lever is sometimes referred to as the bell strike surface 77. The front face of the strike lever is relatively straight longitudinally, but somewhat rounded laterally. When the front surface of the strike lever is relatively straight longitudinally, a portion of the lever face itself will strike the inner surface of the bell in a region near the bell's lip 26. The rounding helps minimize the impact area. The precise impact location will depend on the respective geometries of the strike lever and the inner surface of the bell.

In some embodiments, the inner surface of the dome 20 is filleted at the lip 26 so the strike lever impacts the inner surface of the dome at the fillet. Such a configuration is illustrated in FIG. 6A. In this embodiment, the bell strike surface 77 may be on the fillet 29. FIG. 6B illustrates another bell lip configuration that is not filleted. When such an arrangement is used, the bell strike surface 77 may be the inside edge of the lip 26.

In some embodiments, the strike lever 60 is plastic. An advantage of using plastic is that plastic parts tend to be lower in cost and weight than parts made from metal and/or other materials that might be used to form the strike lever. When the lever's strike surface is formed from plastic it may be desirable to use a filleted bell structure such as the embodiment shown in FIG. 6A so that the inside edge of the lip doesn't gradually cut a groove into the strike lever when the bell is repeatedly rung. When the strike lever 60 or at least the lever strike surface 76 is formed from a stronger material such as a metal, such filleting is less necessary.

In the embodiment illustrated in FIGS. 1-5, the strike surface 76 is a portion of the face of the strike lever 60. However, it should be appreciated that in other embodiments, a hammer (clapper) feature designed to strike an inner surface of the bell may be carried by the strike lever. Some of the embodiments discussed below describe representative hammer features that may be incorporated into the embodiments shown in FIGS. 1-5 as well.

In the illustrated embodiment, finger pad 61 takes the form of an annular ring with an enlarged central opening 62. A potential advantage of using such a central opening is that the weight of the strike lever 60 can be reduced in the region having the longest moment arm from hinge 62 which can be useful in helping the strike lever quickly recoil after striking the bell dome 20 and to damp its motion thereafter. In other embodiments, the finger pad may have other geometries and/or the central opening may be eliminated, or reduced or take the form of a recess rather than a through hole.

In the embodiment shown, the support 40 includes a strap 44 that is suitable for attaching the bell to various structures such as a bar. This allows the bell 10 to be mounted on a variety of different structures, as for example, to a bicycle handlebar (not shown) or other structures having a generally similar circumference. The strap can take a wide variety of different forms. In the illustrated embodiment, the support base 42 includes a threaded recess and an enlarged distal end portion 73 of the strap 44 includes an opening for receiving a strap bolt 71. With this arrangement, the free (distal) end of the strap 44 can be firmly attached support base 42 by screwing the strap bolt into the threaded recess in the support base with the bolt head engaging a shelf adjacent the opening in the end portion 73 of strap 44. The support base may have a strap support surface 72 along which the enlarged end portion 73 of the strap 44 may slide. The threaded recess in the support base, strap support surface 72, end portion 73 of strap 44 and bolt 71 cooperate to provide flexibility in the bar sizes that the bell may be attached to.

The bell dome 20 may be attached to support 40 using a variety of different techniques and mechanisms. In the embodiment of FIGS. 1-5 a cap is utilized to secure the dome 20 to support 40. A suitable cap 50 is illustrated in FIG. 5. In the illustrated embodiment, the cap 50 includes a head 51 and a main shaft 53. The main shaft 53 includes an upper shank portion 55, a groove 58 that defines a reduced diameter neck region 56 and a distal foot or anchor portion 57 below the groove. In the illustrated embodiment, opposing arms of a central loop 82 of the torsion spring 80 pass through the groove 56 on opposite sides of the neck region and serve to hold the cap in place. Thus, the torsion spring serves to both resiliently bias the spring lever to the neutral position and hold the cap 50 in place to firmly secure the bell dome 20 to support 40.

In some embodiments, an upper portion of the support base 42 includes a spacer recess 47 arranged to receive an annular rubber spacer (bushing) 39. The spacer 39 includes a central bore that receives the cap shaft 53 in the region of shank 55.

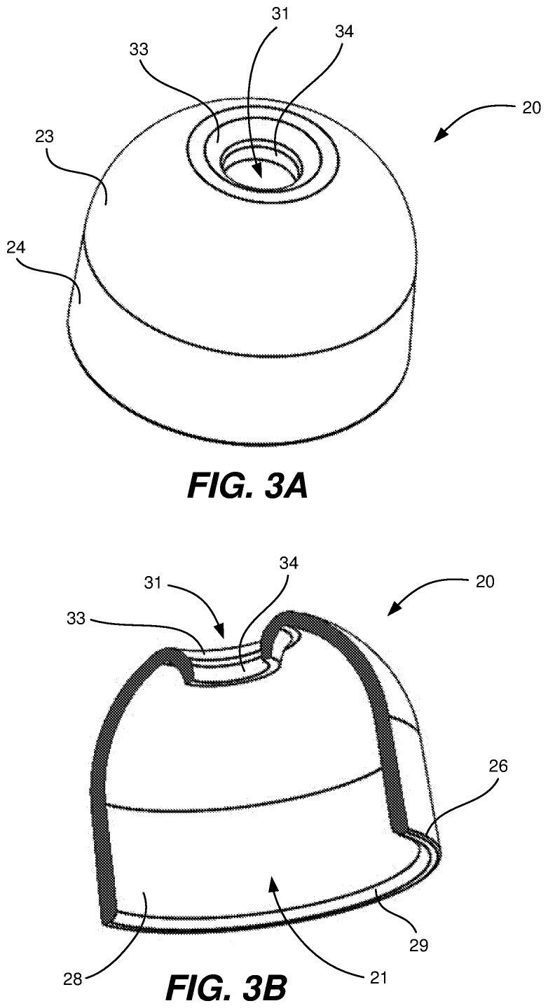

As best seen in FIGS. 3 and 4, the head region of bell dome 20 has an annular bevel 33 that tapers inwardly in the head region around central opening 31. An annular flange 34 extends further down from the inner edge of bevel 33. The annular rubber spacer 39 and annular flange 34 are sized and configured so that the flange 34 rests on the spacer 39 when the bell dome is mounted on the support. In some embodiments the spacer has a somewhat U or J shaped cross section that forms a pocket that receives the flange 34. With this arrangement, neither the flange 34 nor any other portion of the bell dome 20 directly contacts the support 40. Thus, the rubber spacer (bushing) 39 serves to mechanically isolate the dome 20 from the support which allows the dome to vibrate more freely thereby generating a better ring tone than would be obtained if the dome were mounted directly on the support 40.

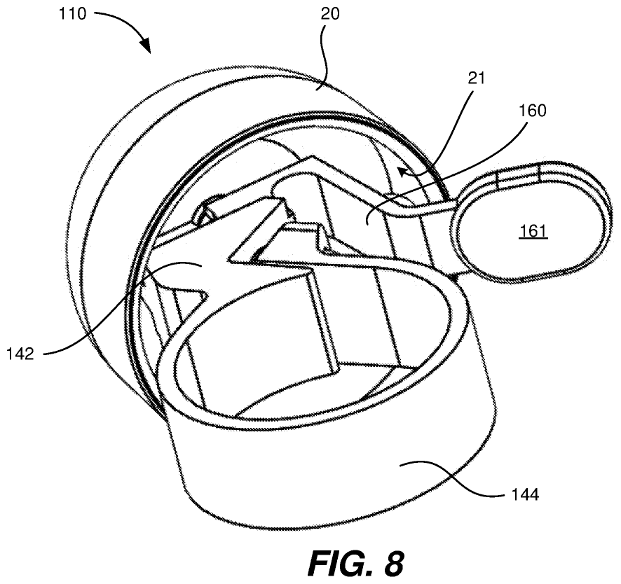

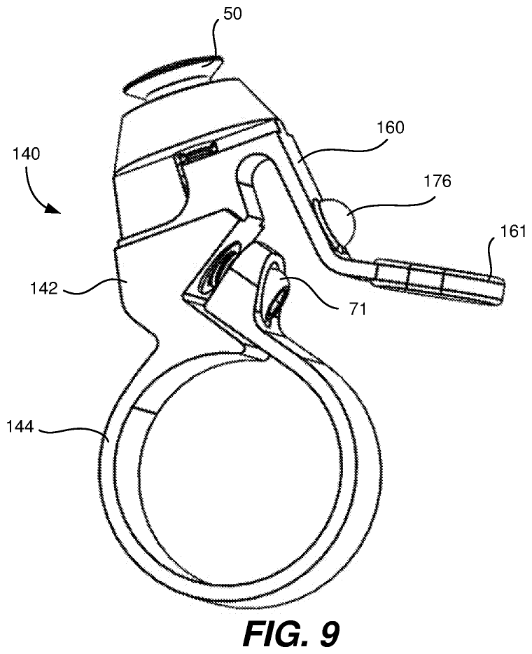

Referring next to FIGS. 8-9, a bell 110 in accordance with a third embodiment that includes a strike lever 160 that is integrated with the support 140 will be described. In the illustrated embodiment, the support base 142 and strike lever 160 are integrally formed as a single plastic part. In this embodiment, the strike lever 160 is cantilevered relative to the support base and functions as a flexure. With this arrangement, the elastic resilience of plastic strike lever 160 provides the spring force that biases the strike lever to a neutral position away from the bell dome. In the illustrated embodiment, the strike lever 160 includes a striker (aka hammer or clapper) 176 which is the element that hits the bell dome 20 to ring the bell. As with the previously described embodiments, the connection between the strike lever 160 and the support base 142 is located within the bell cavity.

A user can ring the bell by pressing on finger pad 161 which causes the strike lever 160 to elastically bend (pivot) inward towards the center of the bell cavity and away from bell dome 20. As in the previous described embodiment, the strap 144 or other component of the support 140 limits the inward movement of the strike lever 160. When the finger pad is released, the strike lever will spring back past the neutral position causing the hammer 176 to strike an internal surface of the bell dome 20 thereby ringing the bell. In some embodiments, the hammer 176 is positioned so that it strikes the inner surface of the bell body at a location above the bell's lip. However, in other embodiments, the hammer can be positioned to strike the inner edge of the bell lip 21 or a fillet on the inner surface of the bell body adjacent the lip as described above with reference to FIG. 6A.

After the bell is rung, the strike lever will recoil back towards the neutral position and the oscillations of the strike lever will quickly dampen—preferably the length, elasticity, positioning and other properties of the strike lever are selected such that the strike lever will quickly rebound after striking the bell and will not contact the bell dome a second time.

In some embodiments, the strap 144 is also integrally formed with the support base 142 and strike lever 160 such that the entire support 140 and strike lever is formed as a single piece. In other embodiments, the support may be formed from multiple pieces.

The embodiment shown in FIGS. 8-9 includes a hammer element 176 that is carried by the strike lever 160. Such a hammer element can also be used on any of the other described embodiments including those shown in the other drawings. The hammer element 176 shown in FIG. 8 takes the form of a nub having a hemispherical geometry that is molded as an integral part of the strike lever. However it should be appreciated that the specific geometry of the hammer element may be widely varied. In other embodiments, the hammer element can be eliminated and the body of the strike lever itself may be arranged to strike an inner surface of the bell body as described above with respect to the embodiment illustrated in FIGS. 1-5.

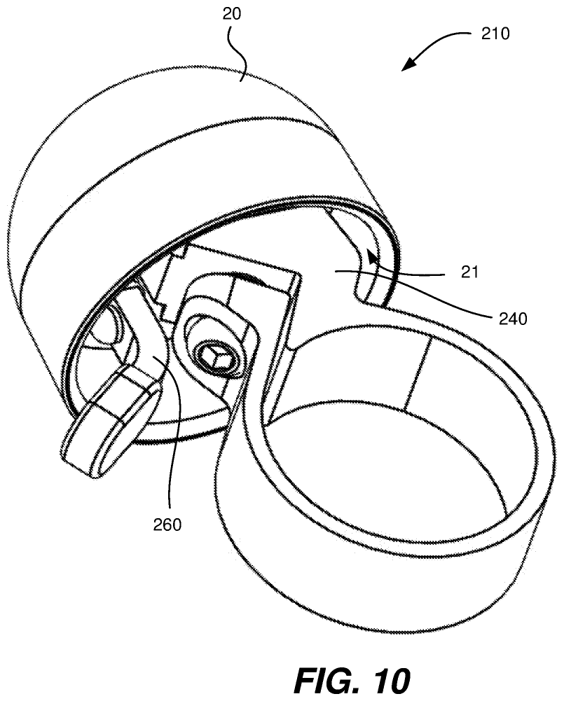

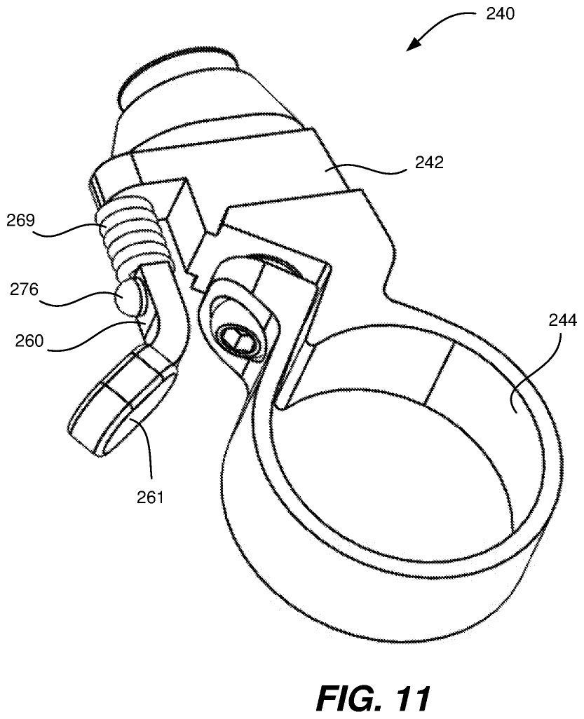

FIGS. 10 and 11 show a bell 210 in accordance with a fourth embodiment. In this embodiment, the support 240 may be coupled to the bell dome 20 in a manner similar to the attachments described above. Strike lever 260 is coupled to the support base 242 by way of a helical coil spring 269. The strike lever includes a finger pad 261 and may optionally include a hammer element 276 similar to the hammer element described above with reference to FIG. 8. The illustrated spring 269 takes the form of an expansion spring—although it should be appreciated that compression springs may be used in other embodiments. In general it is desirable for the spring 269 to have a neutral position that is relatively firm. In some embodiments, a full stack expansion spring is used to provide the firm neutral position.

In the embodiment of FIGS. 10 and 11, depressing the finger pad 261 causes the coil spring to bend elastically away from the bell dome thereby spring loading the strike lever. When the finger pad is released, the elasticity of the coil spring 269 provides the spring mechanism that pulls the strike lever back towards neutral position. As with the other embodiments, the momentum of the strike lever will cause the strike lever to proceed past the neutral position such that the hammer element 276 strikes the inner surface of the bell body to ring the bell. Thereafter, the strike lever will recoil back towards the neutral position and the oscillations of the strike lever will quickly dampen. Again, the various properties of the coils spring and strike lever are preferably selected such that the strike lever will quickly rebound after striking the bell and will not contact the bell dome a second time.

The coils spring 269 is attached to the support base 242 at a location well within the dome cavity and preferably the entire helical spring is located within the dome cavity. Thus, like in the other embodiments, the effective pivot mechanism is located within the dome cavity 21.

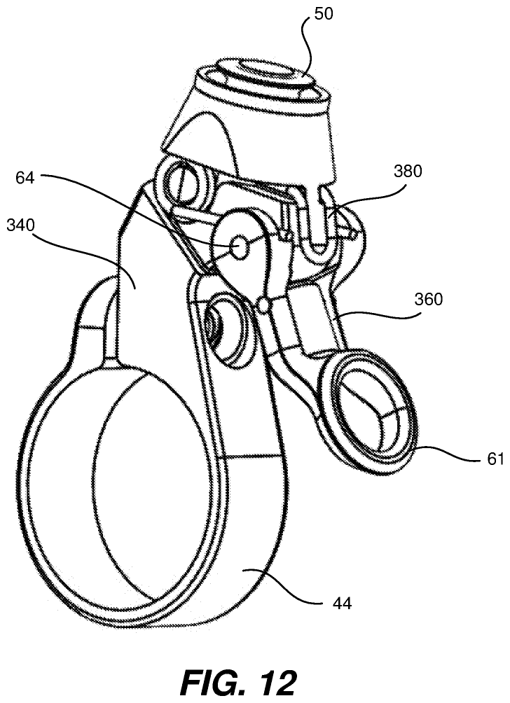

FIGS. 12-14B illustrate yet another strike lever embodiment. In this embodiment, a bell dome 20 (not shown in this view) is attached to the support 340 as previously described. A two part strike lever 360 is pivotally attached to support 340 by pivot pin 64. The two part strike lever 360 includes a lever arm 370 and a hammer element 376 that is pivotally attached to the lever arm 370 via pivot pin 378.

As best seen if FIG. 14B, the lever arm 370 includes hinge 62, a pair of knuckles 63, a pair of cams 66, a pair of arm segments 374, bridge 379, and finger pad 61. As in several of the previously described embodiments, the cams 66 have flat surfaces 67 that the spring arms 81 of spring 80 rest on to define a neutral position for the strike lever. The finger pad 61 is coupled to the hinge by a pair of spaced apart stanchions (arm segments) 374. Bridge 379 extends between the bases of knuckles 63 or upper portions of the stanchions and provide lateral support that helps hold upper ends of the stanchions in place. A relatively large central opening 377 is bounded laterally by stanchions 374 and vertically support bar 379 and the top portion of finger pad 61.

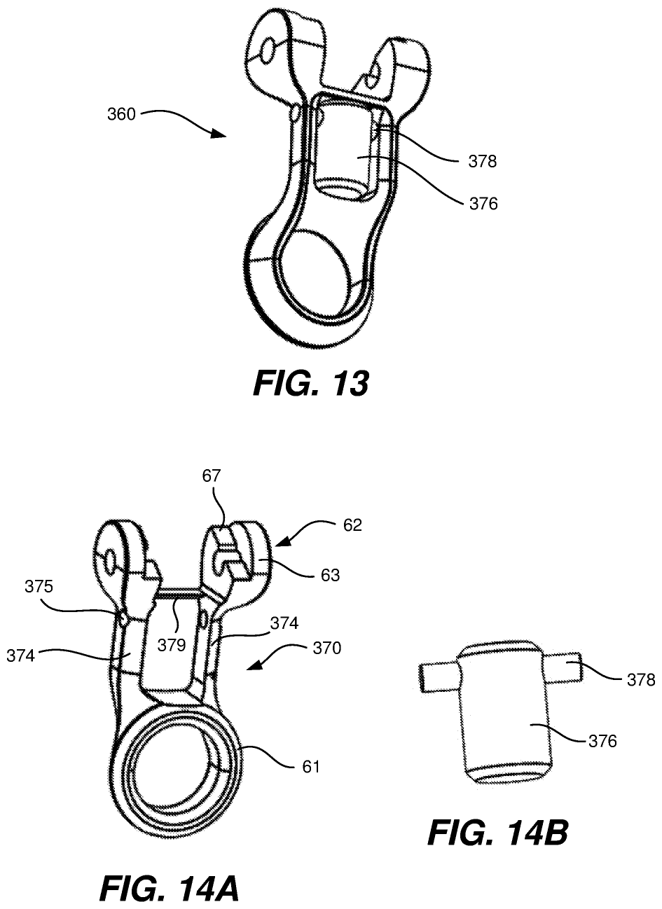

The hammer element 376 is positioned within central opening 377 and is pivotally attached to the stanchions 374 by pivot pin 378 as seen in FIGS. 12 and 13. The hammer element generally swings freely relative to lever arm 370 although its rotation in one direction (towards strap 44) is limited by bridge 379. In the illustrated embodiment, the hammer element 376 has a tapered upper surface 391 that will abut against a tapered lower surface 392 of bridge 379 to limit the hammers inward rotation relative to the lever arm 370. However, in other embodiments, different bridge and hammer element interface geometries may be used. In the illustrated embodiment, the hammer element's inward rotation is limited so that the hammer is generally axially aligned with the lever arm 370 when the bell is upright as seen in FIG. 12. However, in other embodiments, the limit of the hammer's inward range may be angled relative to the axis of the lever arm 370. The hammer's outward rotation (i.e. the rotation of the free end of the hammer element 376 away from strap 44) is not constrained.

In this embodiment the lever arm 370 is constrained so that it will not itself come into contact with the bell dome when the strike lever 360 is depressed and released. In the illustrated embodiment, this is accomplished by the cams 66 under the influence of the force of spring 380. It should be appreciated that the weight, moment arm and geometry of the lever arm 370 together with the geometry of the cams 66 (including the relative length of the flat segments 67) and the force applied by spring 380 must all be designed together to ensure that no portion of the lever arm will contact the bell dome when the bell is rung since such contact would significantly reduce the quality of the ring sound. In other embodiments, a mechanical stop can be provided to limit the forward motion of the lever arm—as for example through the use of a stop bar (not shown) that extends from the base 342.

To ring the bell, the strike lever 360 is loaded by depressing finger pad 61. As in previous embodiments, the strike lever's range of travel may be limited by strap 44 which prevents the strike lever from being depressed too far. The lever arm 370 and the hammer element typically travel together in this movement due to gravity biasing the hammer element 376 against bridge 379. The spring 380 is loaded against the cam 66. When the operator releases the strike lever 360, spring 380 causes the strike lever to swing quickly towards bell dome 20. The flat segments 67 of cam 66 arrest the movement of the lever arm 370 so that the lever arm doesn't swing far enough to strike the bell dome 20. However, since the hammer element 376 is pivotally attached along an axis that is parallel to the strike lever's axis of rotation (e.g., pivot pins 64 and 378 are parallel) momentum and the dynamics of the system will cause the hammer element to swing rapidly about pivot pin 378 causing the hammer element to strike a bottom or corner edge of the bell dome, thereby ringing the bell. Since the hammer element 376 is pivotally attached to the lever arm, it quickly recoils cleanly away from the bell after striking the bell dome which helps ensure that a good ring will be produced by the bell. In this embodiment, it is highly desirable to ensure that the strike lever does not come into contact with the bell, since that can significantly degrade the quality of the ring produced by striking the bell.

The lever arm 370 may be integrally formed as a single piece from plastic or any other suitable material. As can be seen in FIG. 14A, the integrally molded, unitary lever arm 370 may include hinge 62, knuckles 63, cam 66 stanchions 374, bridge 379 and finger pad 61. The hammer element 376 may be formed from a metal such as brass or any other suitable material, including various ceramics or hard plastics.

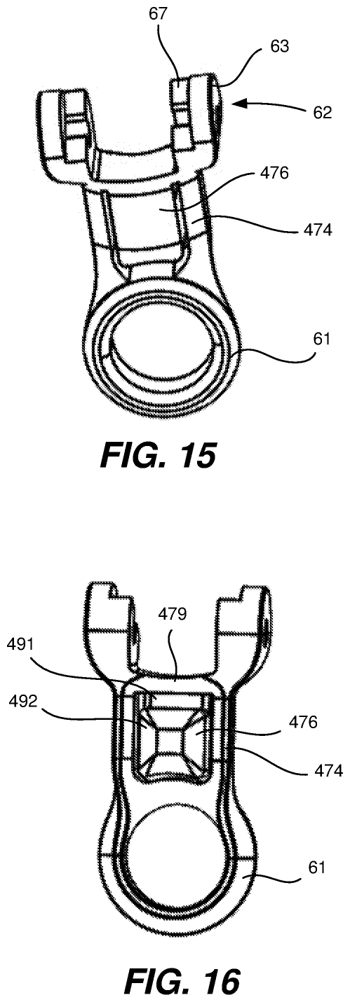

Referring next to FIGS. 15 and 16, a sixth strike lever embodiment will be described. This embodiment has some characteristics in common with two part strike lever discussed above with respect to FIGS. 12-14, but utilizes a living hinge to carry the hammer element such that the hammer element may be integrally formed with the lever arm.

In this embodiment, a bell dome 20 (not shown in this view) is attached to the support 440 as previously described. A strike lever 460 is pivotally attached to support 440 by pivot pin 64. The strike lever 460 includes a lever arm portion 470 and a hammer element 476 that is pivotally attached to the lever arm 470 via living hinge 491.

Somewhat like the fifth embodiment, the lever arm 470 includes hinge 62 having knuckles 63, cams 66 with flat segments 67 that interact with spring 80 as previously described. Additionally, the lever arm includes a pair of spaced apart stanchions 474 that couple finger pad 61 to hinge 62. Bridge 479 extends between the bases of knuckles 63 or upper portions of the stanchions.

The hammer element 476 is positioned in the opening between stanchions 474 laterally and between bridge 479 and finger pad 61 vertically. The hammer element 476 has an enlarged mass 492 and is coupled to bridge 479 by living hinge 491. In the illustrated embodiment, the entire strike lever 460 may be integrally formed as a single plastic molded part (e.g. transfer or injection molded). As such, the unitary strike lever includes knuckles 63, cam 66 stanchions 474, finger pad 61, bridge 479 living hinge 491 and mass 492.

To ring the bell, the strike lever 460 is loaded by depressing finger pad 61. As in previous embodiments, the strike lever's range of travel may be limited by strap 44 which prevents the strike lever from being depressed too far. The lever arm 470 and the hammer element 476 travel together in this movement. The spring is loaded against the cam 66 as the lever is depressed. When the operator releases the strike lever 460, the spring (shown in earlier embodiments) causes the strike lever to swing quickly towards bell dome 20. The flat segments 67 of cam 66 arrest the movement of the lever arm 470 so that the lever arm doesn't swing far enough itself to strike the bell dome 20. However, since the hammer element 476 is pivotally attached along an axis of living hinge 491 that is parallel to the strike lever's axis of rotation, momentum will cause the hammer element 476 to continue swinging outward until it strikes a bottom or corner edge of the bell dome, thereby ringing the bell. Since the hammer element 476 is pivotally attached to the lever arm, it quickly recoils cleanly away from the bell after striking the bell dome which helps ensure that a good ring will be produced by the bell.

Although only a few embodiments of the invention have been described in detail, it should be appreciated that the invention may be implemented in many other forms without departing from the spirit or scope of the invention. In general, the strike lever is coupled to the support base at a location within the bell cavity and extends downward (axially) and outward (radially) beyond the bell's mouth when the strike lever is in its neutral position. When the strike lever is depressed (actuated), the strike lever pivots, deflects or otherwise moves from a neutral position in a pivoting type manner towards the bell's central axis against a resilient force that biases the strike lever back towards the neutral position. Therefore, pressing the strike lever serves to spring load the strike lever. Releasing the strike lever causes the strike lever to swing to strike the bell body to ring the bell. Since the strike lever's effective pivot point is within the bell cavity, the strike lever motion has a vector component that is radially outward relative to the central axis. In some embodiments the radially outward vector component of the strike lever's motion when the bell is rung is at least as great as its axial vector component. In various specific embodiments the radially outward vector component may be 1.5 times, twice, or greater than the axial vector component.

It should be appreciated from the foregoing that the strike lever may be coupled to the support base in a wide variety of different manners and the resilient force that spring loads the strike lever can be provided by a variety of different mechanism. In the various embodiments, the shape and/or size of the bell, the support, the strap, the strike lever, the hammer (if used) and other components may be widely varied.

In many of the described embodiments, the strike lever may be integrally formed from plastic as a single molded component—as for example by transfer or injection molding. Similarly, in many embodiments, the support and strap may be integrally formed from plastic as a single molded component. Such approaches can simplify the manufacturing and assembly processes. However, that is not a requirement and other manufacturing approaches may be used. Therefore, the present embodiments should be considered illustrative and not restrictive and the invention is not to be limited to the details given herein, but may be modified within the scope and equivalents of the appended claims.

What is claimed is:

1. A bell comprising:
a bell body, the bell body including a bell cavity, the bell body having a mouth and a bell strike surface on an inner surface of the bell body;
a support that carries the bell body, wherein a first portion of the support is positioned within the bell cavity and a second portion of the support extend outside the bell cavity through the bell body mouth; and
a strike lever coupled to the support at a location within the bell cavity, the strike lever configured to strike the bell strike surface to ring the bell, wherein the strike lever is resiliently biased towards a neutral position at which the strike lever is spaced apart from the bell body; and
wherein to ring the bell, a user presses the strike lever to deflect the strike lever from the neutral position to thereby spring load the strike lever and move the strike lever away from the bell strike surface, and thereafter releases the strike lever, and wherein when the strike lever is released with the strike lever moved away from the bell strike surface, the spring loading of the strike lever causes the strike lever to swing to strike the bell strike surface on the inner surface of the bell body to ring the bell.

2. A bell as recited in claim 1 wherein the bell body includes a lip and the strike lever is configured to strike the inner surface of the bell at an inner edge of the lip.

3. A bell as recited in claim 1 wherein:
the bell body includes a lip and a filleted surface on the inner surface of the bell body adjacent the lip; and
the strike lever is configured to strike the inner surface of the bell body on the filleted surface.

4. A bell as recited in claim 1 wherein the strike lever includes a strike surface that is substantially straight longitudinally and configured to strike the bell strike surface to ring the bell.

5. A bell as recited in claim 1 wherein the strike lever includes a hammer element that is configured to strike the bell strike surface to ring the bell.

6. A bell as recited in claim 1 wherein the strike lever is pivotally coupled to the support at the location within the bell cavity and the deflection caused by the user pressing the strike lever is pivotal rotation of the strike lever relative to the support.

7. A bell as recited in claim 6 further comprising a torsion spring that spring loads the strike lever when the strike lever is deflected from the neutral position.

8. A bell as recited in claim 6 further comprising a hinge that pivotally couples the strike lever to the support, wherein a first portion of the hinge is formed as part of the support and a second part of the hinge is formed as part of the strike lever.

9. A bell as recited in claim 1 wherein the strike lever includes a strike lever body and the support includes a support body, the strike lever body and the support body being integrally formed from a plastic material with the strike lever serving as a flexure that acts as a flexure that is resiliently biased towards the neutral position at which the lever strike is spaced apart from the bell body.

10. A bell as recited in claim 1 further comprising a helical coil spring that couples the strike lever to the support, wherein the coil spring resiliently biases the strike lever towards the neutral position at which the lever strike is spaced apart from the bell body.

11. A bell as recited in claim 1 wherein the bell body as a central axis and the strike lever is configured to strike the bell strike surface while traveling in a direction having a vector component that is radially outward relative to the central axis.

12. A bell as recited in claim 1 wherein the support includes a loop mount suitable for mounting the bell to a bicycle handlebar.

13. A bell as recited in claim 1 wherein the support and the strike lever are both formed from plastic.

14. A bell as recited in claim 1 wherein the dome shaped bell body includes a substantially hemispherical portion and a substantially cylindrical skirt portion and the bell strike surface is on the skirt portion of the bell body.

15. A bell as recited in claim 1 wherein the bell body includes a head portion having a central opening therein, the bell further comprising a cap that couples the bell body to the support, the cap including a head portion and a shaft, the shaft being configured to pass through the central opening.

16. A bell as recited in claim 7 wherein the torsion spring is configured to:
pull the strike lever from a deflected position when the strike lever is released and cause the strike lever to pass through the neutral position to strike the bell thereby ringing the bell; and
pull the strike lever back towards the neutral position after the strike lever has struck the bell.

17. A bell as recited in claim 7 wherein:
the strike lever includes a lever arm and a hammer element pivotally coupled to the lever arm; and
the torsion spring is configured to pull the strike lever from a deflected position when the strike lever is released and cause the strike lever to pass through the neutral position and thereafter decelerate the lever arm such that the lever arm does not contact the bell while allowing the hammer element to pivot relative to the lever arm to strike the bell thereby ringing the bell and to pull the strike lever back towards the neutral position after the strike lever has struck the bell.

18. A bell comprising:
a dome shaped bell body, the bell body including a dome cavity, a mouth, a lip, a head portion and a central axis, the head portion including a central opening, the bell body further including a filleted bell strike surface on the inner surface of the bell body adjacent the lip;
a plastic support that carries the bell body, wherein a base portion of the support is positioned at least partially within the dome cavity and a strap portion of the support is positioned at least partially outside the dome cavity and is suitable for mounting the bell to a bicycle handlebar;
a cap that couples the bell body to the support, the cap including a head portion and a shaft, the shaft being configured to pass through the central opening;
a plastic strike lever pivotally coupled to the support at a location within the dome cavity, the strike lever including a strike surface configured strike the bell strike surface to ring the bell, wherein the strike lever has a neutral position at which the strike lever is spaced apart from the bell body;
a hinge that pivotally couples the strike lever to the support, wherein a first portion of the hinge is formed as part of the support and a second part of the hinge is formed as part of the strike lever;
a torsion spring that biases the strike lever towards the neutral position and spring loads the strike lever when the strike lever is deflected from the neutral position;
wherein to ring the bell, a user presses the strike lever to rotationally pivot the strike lever from the neutral position to thereby spring load the strike lever and move the strike lever away from the bell strike surface, and thereafter releases the strike lever, and wherein when the strike lever is released with the strike lever moved away from the bell strike surface, the spring loading of the strike lever causes the strike lever to swing to strike the bell body to ring the bell while traveling in a direction having a vector component that is radially outward relative to the central axis.

19. A bell comprising:
a bell body, the bell body including a bell cavity, the bell body having a mouth and a bell strike surface;
a support that carries the bell body, wherein a first portion of the support is positioned within the bell cavity and a second portion of the support extend outside the bell cavity through the bell body mouth; and
a strike lever coupled to the support at a location within the bell cavity, the strike lever including a lever arm and a hammer element carried by and pivotally coupled to lever arm, the hammer element being configured to strike the bell strike surface to ring the bell, wherein the strike lever is resiliently biased towards a neutral position at which the strike lever is spaced apart from the bell body; and
wherein to ring the bell, a user presses the lever arm to deflect the strike lever from the neutral position to thereby spring load the strike lever and move the lever arm and hammer element away from the bell strike surface, and thereafter releases the lever arm, and wherein when the lever arm is released with the lever arm moved away from the bell strike surface, the spring loading of the strike lever causes the strike lever to swing towards the bell strike surface, the movement of the lever arm is constrained so that the lever arm does not strike the bell and the hammer element pivots relative to the lever arm and strikes the bell strike surface.
